(19) United States
(12) Patent Application Publication
(10) Pub. No.: US 2009/0087468 A1
(43) Pub. Date: Apr. 2, 2009

(54) Semi-Rigid Gel Article For Disinfecting A Surface

(76) Inventors: Serena Stephenson, Lake Jackson, TX (US); Nikita R. Manalo, Santa Clara, CA (US); Marc Privitera, Walnut Creek, CA (US); David Lestage, Livermore, CA (US); Maria Ochomogo, Danville, CA (US); Gregory M. Glenn, American Canyon, CA (US)

Correspondence Address: THE CLOROX COMPANY, P.O. BOX 24305, OAKLAND, CA, 94623-1305, US

(21) Appl. No.: 12/039,567

(22) Filed: Feb. 28, 2008

Related U.S. Application Data
(60) Provisional application No. 60/920,696, filed on Mar. 28, 2007.

(51) Int. Cl. A01N 25/34; A01P 1/00

(52) U.S. Cl. 424/408

(57) ABSTRACT

The present invention relates to a semi-rigid gel article which contains an antibacterial agent and can be used for disinfecting and/or cleaning a surface. More particularly, the article comprises water, a gelling agent, an antibacterial agent and wherein the article is capable of disinfecting a surface by contacting the surface with the article, rupturing the article by application of pressure and spreading the article on the surface to deliver the antimicrobial agent. The article is suitable to disinfect and/or clean an inanimate or animate surface with or without water.

### FIELD OF THE INVENTION

The present invention relates to a semi-rigid gel article which contains an antibacterial agent and can be used for disinfecting and/or cleaning a surface. More particularly, the article comprises water, a gelling agent, an antibacterial agent and wherein the article is capable of disinfecting a surface by contacting the surface with the article, rupturing the article by application of pressure and spreading the article on the surface to deliver the antimicrobial agent. The article is suitable to disinfect and/or clean an inanimate or animate surface with or without water.

### BACKGROUND OF THE INVENTION

The constant threat of bacterial contamination and the associated consequences on health have made antimicrobials an essential part of commercial and residential cleaning and disinfection products.

Disinfecting surfaces and hand washing with soap and water are one of the most effective ways to keep from becoming infected with microorganisms or giving them to others.

Disinfecting products currently available today include liquids, lotions, foams and gels which require some type of an applicator to use. Applicators include, for example, squeeze bottles, finger pumps and sprayers, which may be aerosol or non-aerosol. Also known are carriers, such as for example, impregnated wipes, sponges and cloths.

There exists a need for a surface cleaner and/or disinfectant that is easy and convenient to use, for example, on-the-go, in the home at the sink, in a professional or public setting such as a school, grocery store, eating establishment, daycare, hospital, office and the like and with a non-woven, cloth or sponge.

There also exists a need for a cleaner and/or disinfectant that has a predetermined dosage control for effective disinfecting.

There also exists a need for a cleaner and/or disinfectant that is easy to handle and control. Likewise, there exists a need for a cleaner and/or disinfectant that does not spill.

There also exists a need for a skin cleaner and/or sanitizer that can be used with water, optionally soap and water, to ensure that effective disinfecting is achieved.

### SUMMARY OF THE INVENTION

The present invention provides a novel semi-rigid gel article for cleaning and/or disinfecting a surface. The semi-rigid gel article includes water, a gelling agent and an antibacterial agent, which is described in greater detail hereinafter.

In one embodiment, the present invention provides a novel semi-rigid gel article for disinfecting a surface and comprises a gelling agent, water, an antimicrobial agent, and the semi-rigid gel article is of sufficient mechanical strength to allow the entire gel to be picked up without breaking. Optionally, the gelling agent forms a semi-rigid gel article that is able to hold solids, liquids or solutions. Optionally, the gel further comprises a plasticizer in a range that is between about 1% by weight to about 10% by weight.

In another embodiment, the present invention provides a novel semi-rigid gel article for disinfecting a surface comprising, a gelling agent, water, and an antimicrobial agent, wherein the semi-rigid article is capable of disinfecting a surface by contacting the surface with the article, rupturing the article by application of pressure and spreading the article on the surface to deliver the antimicrobial agent and wherein the antimicrobial agent is homogeneously distributed within said article. In another embodiment, the semi-rigid gel article has a storage modulus of at least 2 kPA and a loss modulus of at least 0.3 kPa at about 15° C.-25°. In another embodiment, the article further comprises a plasticizer in a range that is between about 1% by weight to about 10% by weight. In another embodiment, the article further comprises a porous matrix having a solid phase and wherein the pores contain water.

In another embodiment, the present invention provides a novel semi-rigid gel article for cleaning and/or disinfecting a surface comprising water in a range that is between about 60% by weight to about 90% by weight, gelling agent in a range that is between about 4% by weight to about 30% by weight, an antimicrobial agent in a range that is between about 0.001% by weight to about 10% by weight. In another embodiment, the article further comprises a plasticizer in a range that is between about 1% by weight to about 10% by weight. In another embodiment, the semi-rigid gel article has a storage modulus of at least 2 kPA and a loss modulus of at least 0.3 kPa at about 15° C.-25°.

In yet another embodiment, the present invention provides a novel semi-rigid gel article comprising about 4% by weight to about 30% by weight starch, about 60% by weight to about 90% by weight water, about 0.001% by weight to about 10% by weight antimicrobial agent and wherein the semi-rigid article has a storage modulus of at least 2 kPA and a loss modulus of at least 0.3 kPa at about 15° C.-25° and wherein the semi-rigid article is capable of disinfecting a surface by contacting the surface with the article, rupturing the article by application of pressure and spreading the article on the surface to deliver the antimicrobial agent. In another embodiment, the article further comprises a porous matrix having a solid phase and wherein the pores contain water.

In another embodiment, the present invention provides a novel semi-rigid gel article for cleaning and/or disinfecting a surface wherein the gelling agent is selected from the group consisting of starch, agar, alginate, protein, cellulose, silica, cellulose nitrate and alumina or a combination thereof. In another embodiment, the gelling agent is starch.

In another embodiment, the invention relates to methods for using the semi-rigid gel article for cleaning and/or disinfecting a surface. In another embodiment, the invention relates to a method for cleaning and/or disinfecting a surface with a semi-rigid gel comprising providing an article comprised of water, a gelling agent and an antimicrobial agent, contacting the surface with the semi-rigid gel article, rupturing the semi-rigid gel article by application of pressure and spreading the article on the surface to deliver the antimicrobial agent. In another embodiment, the article has a storage modulus of at least 2 kPA and a loss modulus of at least 0.3 kPa at about 15° C.-25° C. In yet another embodiment, the gel article comprises about 60% to about 90% water by weight. In yet another embodiment, the gelling agent is selected from the group consisting of starch, agar, alginate, protein, cellulose, silica, cellulose nitrate and alumina or a combination thereof. In another embodiment, the gelling agent is starch. In another embodiment, the article further comprises a porous matrix having a solid phase and wherein the pores contain water.

These and other aspects will become readily apparent from the detailed which follows.

### DESCRIPTION OF THE DRAWINGS

The various embodiments of the invention will hereinafter be described in conjunction with the appended figures provided to illustrate and not to limit the invention, and in which:

FIGS. 1a and 1b depicts microbial efficacy of the semi-rigid gel article incorporated with an antimicrobial agent on petri dishes.

FIG. 2 shows the average value of the storage modulus.

FIG. 3 shows the average value of the loss modulus.

FIG. 4 shows the average value of the complex viscosity.

### DETAILED DESCRIPTION OF THE INVENTION

The composition and structure of the semi-rigid gel article of the present invention can comprise, consist of or consist essentially of the essential elements and limitations of the invention described herein, as well as any of the additional or optional ingredients, components, or limitations described herein.

Before describing the present invention in detail, it is to be understood that this invention is not limited to particularly exemplified compositions, structures, methods or kits that may, of course, vary. It is also to be understood that the terminology used herein is for the purpose of describing particular embodiments of the invention only, and is not intended to limit the spirit and scope of the invention in any manner.

All publications, patents and patent applications cited herein, whether supra or infra, are hereby incorporated by reference in their entirety to the same extent as if each individual publication, patent or patent application was specifically and individually indicated to be incorporated by reference.

In the application, effective amounts are generally those amounts listed as the ranges or levels of ingredients in the descriptions, which follow hereto. Unless otherwise stated, amounts listed in percentage (“%'s”) are in weight percent of the semi-rigid gel article.

### DEFINITIONS

“Agar”, “Agar-Agar” or equivalent expressions as used herein mean a galactose-based polysaccharide extract of certain seaweeds. “Agarose,” is the neutral gelling fraction of agar (the other being a sulfated non-gelling fraction “agaropectin”).

“Alginate” as used herein means all alginic compounds, the acid and its salts, several derivatives of alginic acid (e.g., calcium, sodium, or potassium salts or propylene glycol alginate), including the insoluble alginic acid and polyvalent salts of alginates, and the soluble alginates including alkali metallic alginates, Mg-alginate and other soluble derivatives of alginic acid, such as propylene glycol alginate. The term “alginate” as used herein comprises any purification level, from technical grade alginate containing low amounts of alginate all the way through ultra purified grades. The term “alginate” also comprises any natural occurring polymer, both from brown seaweeds and from bacterial origin, and enzymatically modified alginate.

“Alumina” as used herein means the use of, for example, aluminum oxide to synthetically make alumina gels.

“Antibacterial agent” or “Antimicrobial agent” are interchangeable as used herein and include agents capable of killing, inhibiting or reducing the growth of any of a broad spectrum of pathogenic microorganisms such as bacteria, yeast, fungi, algae, viruses, and mold.

“Cellulose” as used herein means a long-chain polymeric polysaccharide of beta-glucose and can be used to synthesize materials such as, for example, cellophane and collodion, a solution of nitrocellulose in ether or acetone, and the like.

“Detergent” as used herein means a compound, or a combination of compounds, that is put to use for example, cleaning purposes or stabilizing the formula. A detergent can be a surfactant.

“Diameter” as used herein means the longest line segment with endpoints in a structure or shape.

“Emollient” as used herein means a compound added to increase the moisture content on a surface.

“Gelatin” as used herein means a protein produced by partial hydrolysis of collagen extracted from connective tissues of animals such as porcine and bovines.

“Gelling agent” as used herein means a substance that, when mixed under appropriate conditions with water or other aqueous liquid, converts the water or aqueous liquid from a flowable liquid to a moldable solid, semi-solid, or gel. Appropriate mixing conditions may comprise mixing of the gelling agent in sufficient proportions with water or other aqueous liquid, and/or the application of appropriate heat or pressure.

“Low Amylose Content Starch” comprises 40% or less amylose concentration. “High Amylose Content Starch” comprises 40% or more amylose.

“Oscillatory test” method as used herein means applying an oscillating stress or strain as an input to the semi-rigid gel article and monitoring the resulting oscillatory strain or stress output.

“Sanitize” and “disinfect” are interchangeable as used herein and mean that any of a broad spectrum of pathogenic microorganisms such as bacteria, yeast, fungi, algae, viruses, and mold is killed, inhibited or reduced.

“Semi-Rigid Gel Article” as used herein refers to a porous matrix, wherein the matrix is a solid phase and the pores are at least partially filled with a solvent, capable of incorporating active particles within the matrix and/or the pores of the matrix and capable of maintaining a defined shape. Accordingly, it will not be deformed by or take up the shape of a container.

“Silica” as used herein means the use of, for example, sodium silicate or “waterglass”, to synthetically make silica gels.

“Starch” as used herein means a carbohydrate compound having the formula (C₆H₁₀O₅)ₙ, where the subscript “n” denotes the total number of glucose monomer units. Starches as used herein can be native or unmodified starches or modified starches. Native starches are naturally made and modified starches have been treated chemically to produce some desired change in functionality.

“Surfactant” as used herein means a substance or compound that reduces surface tension. Surfactants include anionic, nonionic, cationic and amphoteric agents. A surfactant can be a detergent.

As used herein and in the claims, the term “comprising” is inclusive or open-ended and does not exclude additional unrecited elements, compositional components, or method steps. Accordingly, the term “comprising” encompasses the more restrictive terms “consisting essentially of” and “consisting of”.

It must be noted that, as used in this specification and the appended claims, the singular forms “a,” “an” and “the” include plural referents unless the content clearly dictates otherwise. Thus, for example, reference to a “surfactant” includes two or more such surfactants.

Unless defined otherwise, all technical and scientific terms used herein have the same meaning as commonly understood by one of ordinary skill in the art to which the invention pertains.

### Methods of Making a Semi-Rigid Gel Article

The semi-rigid gel article of the present invention may be prepared by a variety of techniques known in the art and the methods of preparation will depend on the gelling agent used. For example, when the gelling agent is mixed under appropriate conditions with water or other aqueous liquid, the gelling agent converts the water or aqueous liquid from a flowable liquid to a moldable solid, semi-solid, or gel. Appropriate mixing conditions may comprise mixing of the gelling agent in sufficient proportions with water or other aqueous liquid, and/or the application of appropriate temperature or pressure.

In one embodiment, the gelling agent is starch, agar, alginate, protein, such as gelatin, cellulose, such as cellophane or collodion, silica, cellulose nitrate and alumina and combinations thereof.

### Agar

Agar is insoluble when dispersed as a dry solid in water at low temperatures. Agar becomes soluble when heated to temperatures that are typically between about 70° C. to about 100° C. and form a gel upon cooling. As is known in the art, the exact gelling temperatures of a given agar is dependent on the source of the agar. Hot solutions of agar form gels upon cooling to temperatures that are in a range between about 30° C. to about 60° C. Non-limiting example methods of making agar semi-rigid gels are described in Glenn et al., “Moderate Strength Lightweight Concrete from Organic Aquagel Mixtures”, Industrial Crops and Products 8 (1998) 123-132, herein incorporated by reference in its entirety. Accordingly, making semi-rigid gels with agar includes mixing agar powder with water and heating it to cause the agar to dissolve and form a moderately viscous solution. The solution is then treated to form a semi-rigid gel article in a desired shape. In one embodiment, the agar content is about 0.25% to about 5% by weight. In another embodiment, the agar content is about 1% to about 3% by weight.

### Alginate

Alginate is a polysaccharide extract from brown seaweeds (Phaeophyceae). Non-limiting example methods of making alginate semi-rigid gels are described in Glenn et al., “Moderate Strength Lightweight Concrete from Organic Aquagel Mixtures”, Industrial Crops and Products 8 (1998) 123-132, herein incorporated by reference in its entirety. Accordingly, making semi-rigid gels with alginic acid powder include mixing the powder and water, then injecting or mixing the composition into a calcium ion-containing solution to form a semi-rigid gel article. In one embodiment, the alginate content is about 0.25% to about 3% by weight. In another embodiment, the alginate content is about 1% by weight.

### Protein

A “protein gel” is formed by dispersion of isolated protein products in an appropriate dispersing medium, such as e.g., water or other aqueous solution, and mixing at temperatures that are at or above the gelling temperature, then cooling to form the protein gel. The gelling temperature depends on the type of proteins dispersed and on the dispersing agent employed and is readily determined by one of skill in the art. Non-limiting example methods of making protein, such as gelatin, semi-rigid gels are described in S. S. Kistler “Coherent Expanded Aerogels”, College of the Pacific, Stockton Calif. and Stanford University, pages 52-64, herein incorporated by reference in its entirety.

### Cellulose, Alumina and Silica

Non-limiting example methods of making cellulose, such as cellophane or collodion, silica, and alumina semi-rigid gels are described in S. S. Kistler “Coherent Expanded Aerogels”, College of the Pacific, Stockton Calif. and Stanford University, pages 52-64, herein incorporated by reference in its entirety.

### Starch

Starch and its derivatives are widely used in the manufacture of foods, paper, textiles, adhesives, pharmaceuticals, and building materials. The general classes of starch include native or unmodified starches and modified starches. Native starches are naturally derived from plants, tubers, roots or piths. Modified items have been treated chemically to produce some desired change in functionality.

Most starches are a mixture of amylose and amylopectin. Amylose is a linear polymer and amylopectin is a highly branched polymer. The tensile properties of starch are decreased by amylopectin, because the branched molecules cannot orient and pack as closely as linear molecules. The ratio of amylose to amylopectin is fairly constant for a given species of starch. (Whistler, et al., “Starch: Chemistry and Technology”, Second Edition, Academic Press, 1984, hereby incorporated by reference.)

Suitable starches of the present invention include modified and unmodified starches. Unmodified or native starches are naturally made and derived from, for example, plants, tubers, roots or piths. Unmodified starches include, but are not limited to, cornstarch (including maize starch and regular cornstarch), potato starch, wheat starch, tapioca starch (including cassaya starch and manioc starch), waxy maize starch (including waxy cornstarch and amioca), sorghum starch (including milo starch), rice starch, sago starch, arrowroot starch, sweet potato starch, guar gum, locust bean, arracacha, buckwheat, banana, barley, cassaya, konjac, kudzu, oca, taro, yams, beans and mixtures thereof. Modified starches have been treated chemically to produce some desired change in functionality. Modification can be accomplished by a chemical reaction of, for example, the hydroxyl group by esterification, etherification or oxidation. Alternatively, modification can be accomplished by disturbance of the initial structure, as in the case of dextrins.

Non-limiting example methods of making starch gels are described in Whistler, et al., “Starch: Chemistry and Technology”, Second Edition, Academic Press, 1984; and Van Beynum, G. M. A., et al., “Starch Conversion Technology”, Marcel Dekker, Inc., 1985; U.S. Pat. No. 5,958,589; and Glenn et al., “Moderate Strength Lightweight Concrete from Organic Aquagel Mixtures”, Industrial Crops and Products 8 (1998) 123-132; all of which are herein incorporated by reference in their entirety. In general, the order of addition of the base components includes mixing the water and starch, optionally other ingredients, in a beaker and thoroughly mixing with, for example, a constant speed bench mixer. Once the composition is well mixed, a hot plate is turned on and the composition is gradually heated past its gelatinization point for about 30 to 45 minutes to a temperature between about 90° C. and about 95° C. The temperature is held here for about 1 to about 20 minutes depending on the type of starch and allowed to gelatinize. Under constant stirring, the starch composition is allowed to cool to about 85° C. to about 75° C. to form a paste.

Lastly, the starch paste is dropped by pipette onto a hard surface or directly into a package and allowed to set up for 1-4 hours, depending on the composition and size of the semi-rigid gel article. At this point, the temperature of the semi-rigid gel article is at room temperature. Once the article can be handled, it is ready to be coated for packaging or packaged in a water-impermeable system.

In one embodiment, the starch is unmodified or modified. In another embodiment, the starch is unmodified. In another embodiment, the starch is corn, wheat or sorghum. In yet another embodiment, the starch is corn.

In one embodiment, the starch has a low amylose content. In one embodiment, the amylose content is about 10% to about 40%. In another embodiment, the amylose content is about 15% to about 35%. In yet another embodiment, the amylose content is about 25% to about 30%.

In another embodiment, the starch has a high amylose content. In one embodiment, the amylose content is about 40% to about 95%. In another embodiment, the amylose content is about 70% to about 80%.

In one embodiment, the starch is present in an amount of from about 1% to about 40% by weight of the semi-rigid gel article. In another embodiment, the starch is present in an amount of from about 4% to about 30% by weight of the semi-rigid gel article. In another embodiment, the starch is present in an amount of about 6% to about 15% by weight of the semi-rigid gel article. In yet another embodiment, the starch is present in an amount of about 6% to about 10% by weight of the semi-rigid gel article.

In an alternate procedure, the gelling agent is mixed with water, gelatinized, poured into a mold, and dried. The dried material is formed into pieces and hydrated into a semi-rigid gel article. Likewise, semi-rigid gels made of other gelling agents and/or solvents can be prepared by methods known in the art without undue experimentation.

The semi-rigid gel articles of the present invention have a high water content. In one embodiment, the water is present in a weight percent amount of about 60% to about 95% of the semi-rigid gel article. In another embodiment, the water is present in a weight percent amount of about 70% to about 90% of the semi-rigid gel article. In yet another embodiment, the water is present in a weight percent amount of about 80% to about 90% of the semi-rigid gel article.

In one embodiment, the water at least partially fills the pores of the semi-rigid gel article. In another embodiment, water is mixed with another liquid or solvent.

In another embodiment, an antimicrobial agent is added to provide sanitizing or disinfecting properties, persistence, or as a preservative. One or more antibacterial agents may be added.

Suitable antimicrobial agents include, but are not limited to:

Acids: Lactic, citric, glycolic, organic/inorganic acids, gallic, hydroxy-benzoic acid; and derivatives and esters;

Alkaline Agents: Ca(OH)₂, NaOH, KOH;

Biguanides: Polyhexamethylene biguanide (PHMB), bis-biguanide alkanes such as chlorhexidine gluconate (CHG), including combinations with other actives, such as Surfacine® (PHMB and silver iodide);

Dyes: Gentian, or crystal violet, ethyl violet, brilliant green, etc., and the FD&C dyes such as Blue No. 1 and Green No. 3. In addition, other dyes include the following FD&C and D&C colors: (1) Monoazo dyes such as, but not limited to, FD&C Yellow No. 5, FD&C Yellow No. 6, (2) Diazo dyes such as, but not limited to, D&C Red No. 17, (3) Indigoid dyes such as, but not limited to, FD&C Blue No. 2, (4) Xanthene (Fluorescein) dyes such as, but not limited to, FD&C Red No. 3, (5) Anthraquinone dyes such as, but not limited to, D&C Green No. 6, (6) Quinoline dyes such as, but not limited to, D&C Yellow No. 1.; Halogens: NaOCl, Ca(OCl)₂, ClO₂;

Inorganic oxides/hydroxides: Insoluble inorganic oxides with isoelectric points greater than the pH of the solution have been shown to be efficient at the physical removal of microorganisms (bacteria and virus). Examples include magnesium hydroxide, magnesium oxide, aluminum oxide, iron oxide, cerium oxide, zinc oxide, zirconium oxide, barium oxide, calcium oxide, hydroxyapatite, chromium oxide, cobalt oxide, cesium oxide, and chrysotile asbestos;

Metals: Metal salts, which generally includes salts of metals in groups 3B-7B, 8 and 3A-5A. Specifically are the salts of aluminum, zirconium, zinc, silver, gold, copper, lanthanum, tin, mercury, bismuth, selenium, strontium, scandium, yttrium, cerium, praseodymiun, neodymium, promethum, samarium, europium, gadolinium, terbium, dysprosium, holmium, erbium, thulium, ytterbium, lutetium, including silver dihydrogen citrate (Tinosan®);

Naturals: Also useful as antimicrobial agents are those referred to as “natural essential oils”. These actives derive their names from their natural occurrence in plants. Typical natural essential oil antibacterial actives include oils of anise, lemon, orange, rosemary, wintergreen, thyme, lavender, cloves, hops, tea tree, citronella, wheat, barley, lemongrass, cedar leaf, cedarwood, cinnamon, fleagrass, geranium, sandalwood, violet, cranberry, eucalyptus, vervain, peppermint, gum benzoin, basil, fennel, fir, balsam, menthol, ocmea origanum, hydastis carradensis, Berberidaceae daceae, ratanhiae and curcuma longa. Also included in this class of natural essential oils are the key chemical components of the plant oils which include, but are not limited to, anethol, catechole, camphene, carvacol, eugenol, eucalyptol, ferulic acid, farnesol, hinokitiol, tropolone, limonene, menthol, methyl salicylate, thymol, terpineol, verbenone, berberine, ratanhiae extract, caryophellene oxide, citronellic acid, curcumin, nerolidol and geraniol. Also useful are agents derived from naturally occurring materials, such as chitin, also known as chitosan;

Oxidants: H₂O₂, Perborate;

Phenols: Triclosan, PCMX;

Quats: Ammonium salts like benzalkonium chloride, benzethonium chloride and cetrimide; and mixtures thereof.

In one embodiment, the antimicrobial agent is a biguanide, natural, acid, chitosan, triclosan, quats or metal. In another embodiment, the antimicrobial agent is PHMB, PHMB and silver iodide, natural oil, chitosan, lactic acid, glycolic acid, or silver citrate.

The level of antimicrobial agent is selected to provide the desired level of antimicrobial activity and can be modified as desired. In one embodiment, the antimicrobial agent is present in an amount of from about 0.001% to about 10% by weight of the semi-rigid gel article. In another embodiment, the antimicrobial agent is present in an amount of from about 0.001% to about 5% by weight of the semi-rigid gel article. In another embodiment, the antimicrobial agent is present in an amount of about 0.003% to about 3% by weight of the semi-rigid gel article.

A plasticizer can be added to affect the elasticity and tensile strength of the semi-rigid gel article. Suitable plasticizers include, but are not limited to, polyhydric alcohols (i.e. polyols), amino alcohols, hydroxyalky amides and mixtures thereof. Other suitable plasticizers include glycerol, diethylene glycol, sorbitol, sorbitol esters, maltitol, malitol, mannitol, sucrose, fructose, invert sugars, corn syrup, and mixtures thereof. In one embodiment, the plasticizer is a polyol. In another embodiment, the plasticizer is glycerol.

In one embodiment, the plasticizer is present in an amount of from about 1% to about 10% by weight of the semi-rigid gel article. In another embodiment, the plasticizer is present in an amount of from about 1% to about 6% by weight of the semi-rigid gel article. In another embodiment, the plasticizer is present in an amount of about 2% to about 4% by weight of the semi-rigid gel article.

In one embodiment, the gelling agent to plasticizer ratio is about 1:1. In another embodiment the gelling agent to plasticizer ratio is about 2:1. In yet another embodiment, the gelling agent to plasticizer ratio is about 6:1.

In another embodiment, a microcapsule or beadlet as described in U.S. Pat. No. 6,045,813 to Ferguson et al. and US2005/0271595 to Brown, both of which are incorporated herein by reference, is added to the article at any appropriate point in the process of making the semi-rigid gel article. In one embodiment, the beadlet has a diameter of about 25 μm to about 2000 μm. In another embodiment, the beadlets have a diameter of about 50 μm to about 1500 μm. In yet another embodiment, the beadlets have a diameter of about 500 μm to about 1500 μm.

The beadlets may be filled with an antimicrobial agent and/or a different active, for example, fragrance, color, abrasive, surfactant or emollient. In one embodiment, an antimicrobial agent and a beadlet filled with an antimicrobial agent are added to the composition. The antimicrobial agent may be the same or different. In another embodiment, the beadlet is filled with an active other than an antimicrobial agent. The amount of beadlets added is selected to provide the desired level of activity and can be modified as desired.

The beadlets may be ruptured to release the active, for example, by application of pressure. Alternatively, the beadlets may be ruptured when the semi-rigid gel article is discharged from packaging.

In another embodiment, the beadlets are rehydrated in water before they are added to the composition. Accordingly, about 2-3 grams of beadlets are added to about 20 ml of water and soaked for about 2 hours. The water is drained off before addition to the composition.

Also suitable for use in the present invention are surfactants or detergents. Surfactants may be used to reduce surface tension. Surfactant as used herein includes anionic, nonionic, and amphoteric agents. A surfactant can be a detergent. Detergents may be used for cleaning purposes or stabilizing the composition. A detergent can be a surfactant.

Non-limiting examples of surfactants or detergents include alkylpolyglucosides, esters of fatty acids and hydrophilic alcohols, sorbitans, alkanolamides, soaps, sarcosinates, sulfoacetates, sulfosuccinates, cocoamphocarboxy glycinate, salts of higher acyl esters of isethionic acid, salts of higher acyl derivatives of taurine or methyltaurine. In one embodiment, the surfactant includes betaines, lauryl sulfate, laureth sulfate, C11 alcohol ethoxylates, cetyl stearyl alcohol ethoxylate, cocamidopropyl dimethylamine proprionate, cocamidopropyl amine oxide, and cocamidopropyl betaine. In yet another embodiment, the surfactant is sodium lauryl sulfate, betaines or alkylpolyglucosides.

The surfactant or detergent is added to the article at any appropriate point in the process of making the semi-rigid gel article. The level of surfactant or detergent is selected to provide the desired level of activity and can be modified as desired.

Also suitable for use in the present invention are emollients. Emollients may be added to increase the moisture content on, for example, a skin surface. Emollients are generally separated into two broad classes based on their function. The first class of emollients function by forming an occlusive barrier to prevent water evaporation from a skin surface. The second class of emollients penetrate into the skin and physically bind water to prevent evaporation. The first class of emollients is subdivided into compounds which are waxes at room temperature and compounds which are liquid oils. The second class of emollients includes those which are water soluble and are often referred to as humectants.

Non-limiting examples of emollients are short chain alkyl or aryl esters (C1-C6) of long chain straight or branched chain alkyl or alkenyl alcohols or acids (C8-C32) and their polyethoxylated derivatives; short chain alkyl or aryl esters (C1-C6) of C4-C12 diacids or diols optionally substituted in available positions by —OH; alkyl or aryl C1-C10 esters of glycerol, pentaerythritol, ethylene glycol, propylene glycol, as well as polyethoxylated derivatives of these and polyethylene glycol; C12-C22 alkyl esters or ethers of polypropylene glycol; C12-C22 alkyl esters or ethers of polypropylene glycol/polyethylene glycol copolymer; and polyether polysiloxane copolymers. Additional examples of occlusive emollients include cyclic and linear dimethicones, polydialkylsiloxanes, polyaryl/alkylsiloxanes, long chain (C8-C36) alkyl and alkenyl esters of long straight or branched chain alkyl or alkenyl alcohols or acids; long chain (C8-C36) alkyl and alkenyl amides of long straight or branched chain (C8-C36) alkyl or alkenyl amines or acids; hydrocarbons including straight and branched chain alkanes and alkenes such as squalene, squalane and mineral oil; jojoba oil, polysiloxane, polyalkylene copolymers, dialkoxy dimethyl polysiloxanes, short chain alkyl or aryl esters (C1-C6) of C12-C22 diacids or diols optionally substituted in available positions by OH such as diisopropyl dimer dilinoleate; and C12-C22 alkyl and alkenyl alcohols, long chain alkyl or aryl esters (C8-C36) of C12-C22 diacides or diols optionally substituted in available positions by —OH, such as diisostearyl dimer dilinoleate; lanolin and lanolin derivatives, and beeswax and its derivatives. Additional examples of emollients include Lauric Acid, Palmitic Acid, Myristic Acid, PEG-3 Glyceryl Cocoate, Propylene Glycol Diperlargonate, Octyl Stearate, Ceteth-10, Glycereth-26, Isocetyl Stearate, Octyldodecyl Stearoyl Stearate, Isopropyl Isostearate, Isostearyl Isostearate, Isostearyl Palmitate, Myristyl Stearate, Myristyl Lactate, Myristyl Myristate, Octyl Palmitate, PEG-7 Glyceryl Cocoate, Cetyl Esters, Isostearyl Neopentanoate.

The level of emollient is selected to provide the desired level of activity and can be modified as desired. In one embodiment, the emollient is glycerol, propylene glycol, dipropylene glycol, polypropylene glycol, polyethylene glycol, sorbitol, pantothenol, gluconic acid salts, shea butter, cocoa butter, dimethicone/cyclomethicone (silioxanes) or commercially available materials, such as POLAWAX® from Croda. In another embodiment, the emollient is glycerol.

In another embodiment, other actives or ingredients are added to the composition to affect the performance of the semi-rigid gel article as desired. Non-limiting examples include, abrasives, anesthetic, colorant, fragrance, encapsulated actives, essential oils, flame suppressants, flash-point suppressants, color change indicators, insect repellants, pearlizing agents, pharmaceuticals, preservatives, skin conditioners, skin sensates, surfactants, sunscreen agents, vitamins, and the like.

The order of addition of the antimicrobial agent or other actives and ingredients to the semi-rigid gel article will depend on a number of considerations, including the hydration requirements, thermal stability, viscosity, volatility and convenience. Accordingly, one skilled in the art could prepare the semi-rigid gels including at least one antimicrobial agent and capable of disinfecting a surface by methods known in the art without undue experimentation.

In another embodiment, the semi-rigid gel article is formed into any desired shape or form, including but not limited to, beads, spheres, balls, circles, rounds, ovals, tubes, discs, squares, hearts, letters, people, children, babies, flowers, trees, fish, stars, animals, commercial logos and the like.

In another embodiment, the semi-rigid gel article has a diameter from about 1 mm to about 50 mm. In another embodiment, the semi-rigid gel article has a diameter from about 6 mm to about 25 mm. In yet another embodiment the semi-rigid gel article has a diameter from about 4 mm to about 12 mm.

In another embodiment, the semi-rigid gel article is coated to prevent water from evaporating or to provide a semi-rigid gel article which may be conveniently handled and/or packaged. The coating may be applied, for example, by dipping the semi-rigid gel article into the coating, spraying the coating on the semi-rigid gel article, wrapping the semi-rigid gel article up in a thin film coating or dripping the coating over the semi-rigid gel article. Optionally, the semi-rigid gel article coating is allowed to dry before handling or packaging.

The rigidity or solidity of a semi-rigid gel article is influenced by the nature and/or concentration of the solvent that fills the pores, as well as by the nature of the gelling agent. Thus, the degree of solidity/rigidity of the semi-rigid gel articles can be varied and is numerically determined by measuring e.g., the compressive strength, the compressive modulus, and/or the dynamic modulus using methods disclosed herein, and/or by using other methods known in the art (see e.g., U.S. Pat. No. 4,794,788).

In one embodiment, the semi-rigid gel article has a linear viscoelastic response as measured by an oscillatory test using a Dynamic Mechanical Analyzer (DMA). Oscillatory test method as used herein means applying an oscillating stress or strain as an input to the semi-rigid gel article and monitoring the resulting oscillatory strain or stress output. The same repetitive sinusoidal straining motion recurs over and over again, with each cycle taking a certain time, and having a frequency that is inversely proportional to that time. (Barnes, Howard A., “A handbook of Elementary Rheology”, Institute of Non-Newtonian Fluid Mechanics, University of Wales, 2000, herein incorporated by reference.)

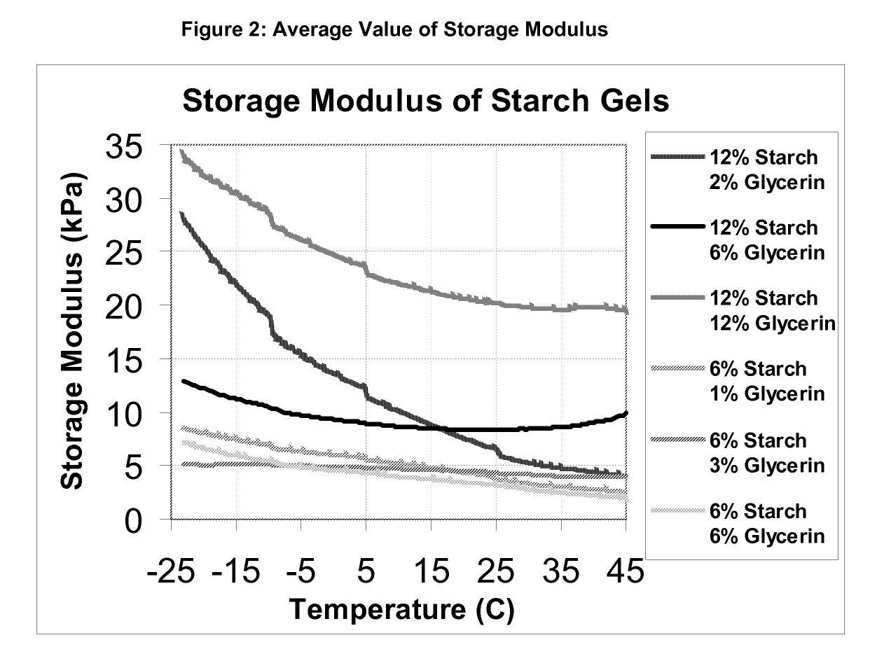

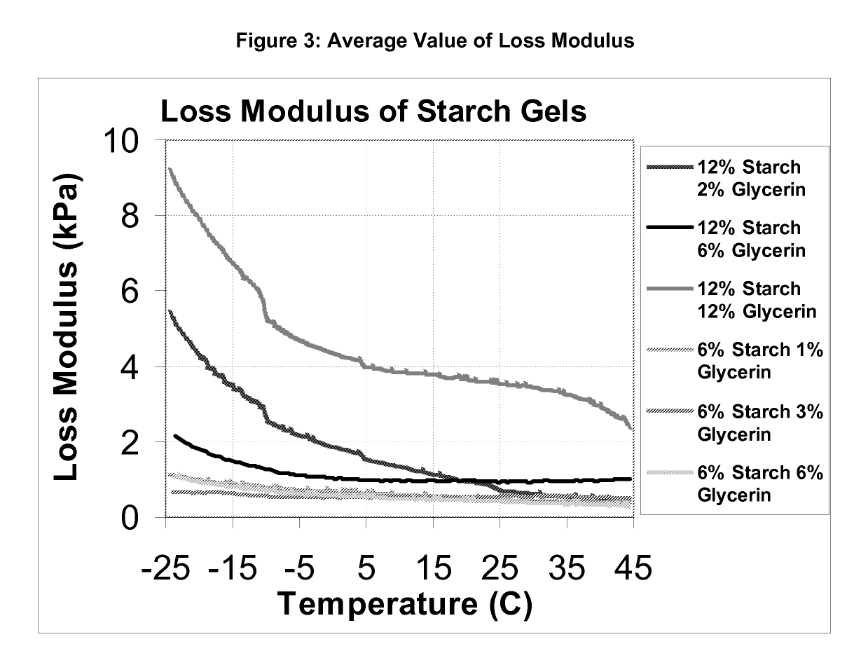

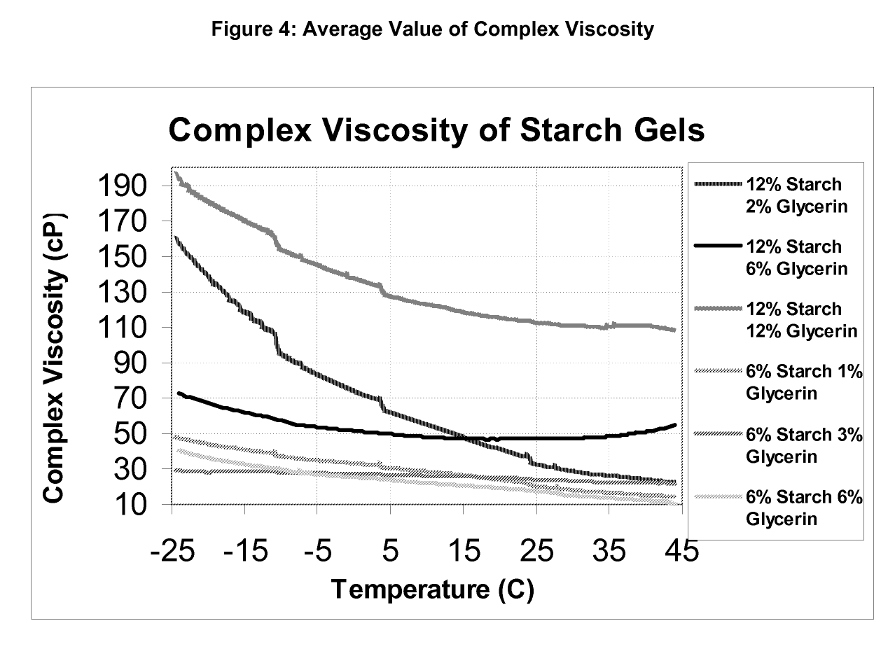

Accordingly, at about 15° C.-25° C. the semi-rigid gel article of the present invention has a storage modulus of at least 2 kPa. In another embodiment, the storage modulus is about 2 kPA to about 22 kPa (see Example 7, FIG. 2). In another embodiment, the storage modulus is about 2 kPa to about 6 kPa. In another embodiment, the semi-rigid gel article has a loss modulus of at least 0.3 kPa. In another embodiment, the loss modulus is about 0.3 kPa to about 5 kPa (see Example 7, FIG. 3). In another embodiment, the loss modulus is about 0.4 kPa to about 1 kPa. In yet another embodiment, the semi-rigid gel article has a complex viscosity of about at least 13 cP. In another embodiment, the complex viscosity is about 13 cP to about 120 cP (see Example 7, FIG. 4). In another embodiment, the complex viscosity is about 10 cP to about 30 cP. In another embodiment, the semi-rigid gel article has a dynamic viscosity of at least 1.5 cP. In another embodiment, the dynamic viscosity is about 1.5 cP to about 23 cP. In yet another embodiment, the dynamic viscosity is about 1.5 cP to about 3.5 cP.

### Methods for Cleaning or Disinfecting a Non-Skin Surface

In one embodiment, the semi-rigid gel article of the present invention is useful for cleaning and/or disinfecting a non-skin surface, such as household surfaces, i.e. countertops, kitchen surfaces, food preparing surfaces (cutting boards, dishes and the like); major household appliances, i.e., refrigerators, washing machines, automatic dryers, ovens, dishwashers, cabinets; walls, floors, bathroom surfaces, and the like. In another embodiment, the semi-rigid gel article can be used with or without water. In another embodiment, the semi-rigid gel article is used with a non-woven, cloth or sponge.

In another embodiment, the semi-rigid gel article is contacted with a hard surface, such as a countertop, and ruptured by applying pressure, such as by hand or an implement, and spread over the surface to deliver the antimicrobial agent and thereby disinfects the surface.

### Methods for Cleaning or Disinfecting a Skin Surface

In one embodiment, the semi-rigid gel article of the present invention is useful for cleaning and/or sanitizing the skin when soap and water are not available or convenient to use. Alternatively, the semi-rigid gel article can be used with water, or soap and water.

### Waterless Application

In one embodiment, the waterless skin cleaning and/or sanitizing process involves contacting the semi-rigid gel article with a hand. Applying pressure to the article by rubbing the semi-rigid gel article between two hands to release the antimicrobial active and spreading or rubbing the semi-rigid gel article until the bead is absorbed or dissolved.

In another embodiment, the waterless skin cleaning and/or sanitizing process involves contacting the semi-rigid gel article with a hand. Applying pressure to release the antimicrobial active. Rubbing or spreading the semi-rigid gel article between two hands and between fingers and/or under fingernails to thoroughly coat the hands. The semi-rigid gel article should be rubbed until it is absorbed or dissolved.

### Water Aided Application

In one embodiment, the water aided skin cleaning and/or sanitizing process involves wetting the hands with water. Applying pressure to the article by rubbing the semi-rigid gel article between the wet hands to release the antimicrobial active and spreading or rubbing the semi-rigid gel article over the surfaces of the hands to deliver the antimicrobial agent and, lastly, rinsing the hands with water and allowing them to air dry or dry with a towel.

In another embodiment, the water aided skin cleaning and/or sanitizing process involves contacting the semi-rigid gel article with a dry hand. Applying pressure to release the antimicrobial active. Rubbing the semi-rigid gel article between two hands and then rinsing with water. The hands can be air dried or dried with a towel.

The amount of the semi-rigid gel article applied, the frequency of application and the period of use will vary widely depending upon the level of cleaning and/or disinfection desired, e.g., the degree of microbial contamination.

### Methods of Packaging

The inventive semi-rigid gel article of the present invention has a high water content, for example, from about 60% to about 95% water, and is preferably sealed or coated to prevent evaporation of the water during storage.

In one embodiment, the semi-rigid gel article is coated or conveniently packaged to prevent water from evaporating. The coating may be applied, for example, by dipping the semi-rigid gel article into the coating, spraying the coating on the semi-rigid gel article, wrapping the semi-rigid gel article up in a thin film coating or dripping the coating over the semi-rigid gel article. Optionally, the semi-rigid gel article coating is allowed to dry before handling or packaging.

In another embodiment, the article is dropped by pipette directly into a package and allowed to gelatinize or cool and set up before sealing. Non-limiting examples of packaging systems include those described in U.S. Pat. No. 3,924,747 to Haines, herein incorporated by reference, which describes a blister package with perforated tabs for access to contents, which are covered by rupturable foil. Also, U.S. Pat. No. 3,809,220 to Arcudi, herein incorporated by reference, which describes a sealed package made of a plastic film and tears open when manipulated to expose a hidden tear zone. Also, U.S. Pat. No. 4,120,400 to Kotyak, herein incorporated by reference, which describes a package constructed of a blister card slidably mated to an outer covering. Also, US20060027483 Aldridge, US20030080021 Kopecky, US20030080020 Kopecky, U.S. Pat. No. 7,000,769 Killinger, U.S. Pat. No. 6,776,288 Kopecky, U.S. Pat. No. 6,523,691 Raj, U.S. Pat. No. 5,310,060 Bitner, U.S. Pat. No. 5,046,618 Wood, U.S. Pat. No. 4,485,915 Berghahn, U.S. Pat. No. 4,231,477 De Felice, U.S. Pat. No. 4,192,422 Kotyuk, U.S. Pat. No. 3,941,248 Moser, U.S. Pat. No. 3,912,082 Gerner, U.S. Pat. No. 3,899,080 Brunda, U.S. Pat. No. 3,809,221 Compere, all of which are hereby incorporated by reference.

### OTHER EMBODIMENTS

In another embodiment of the present invention, the article is treated to replace the water in the gel with a first exchange solvent that is effective for displacing water in the article and that does not substantially solubilize the starch. In another embodiment, the first exchange liquid is a C1-C4 alcohol, such as ethanol, 2-propanol (or isopropanol), n-propanol, n-butanol, methanol and combinations thereof. A singe alcohol or a blend of two or more alcohols may be used. Such embodiments are described in “SEMI-RIGID GEL CLEANSING ARTICLE” by Glenn ______, concurrently filed herewith on even date, and incorporated in its entirety.

In another embodiment of the present invention, the article is cast as a thin film and allowed to cool and dry-out. A process for making starch based thin films is described in WO 2005/118729, Hedley et al, incorporated herein by reference, which describes the steps of providing a composition of starch, water and a polyol, heating the composition with agitation to form a starch paste and cooling and drying the starch paste to form a starch film. In the present invention, an antimicrobial agent is added to the composition before or after heating, depending on the properties of the agent.

The films of the present invention are cast using draw bars from about 5 mil (0.127 mm) to about 50 mil (1.27 mm). In one embodiment, the films are cast using draw bars of about 5 mil (0.127 mm) to about 15 mil (0.381 mm). In another embodiment, the films are cast using a draw bar of about 40 mil (1.016 mm) to about 50 mil (1.27 mm) The dried films have a thickness of about 0.02 mm to about 2 mm or a thickness of about 0.05 mm to about 1.5 mm or a thickness of about 0.075 mm to about 1.25 mm.

In another embodiment, the semi-rigid gel article of the present invention is useful for delivering a variety of agents to humans and other animals to produce a therapeutic, sensory, pharmacological, or cosmetic effect, including breath fresheners, flavors, fragrances and pharmaceuticals.

In another embodiment, the semi-rigid gel article of the present invention is useful for delivering flavor to food while it's cooking. For example, the semi-rigid gel article is placed on top of the food or in a cavity before cooking. The food is then placed in an oven. The moisture present during cooking will dissolve the semi-rigid gel article and allow the flavor to spread over the food. Optionally, the dissolved semi-rigid gel article will deliver an extra burst of flavor fragrance or aroma.

In another embodiment, the semi-rigid gel article of the present invention is useful for delivering actives to water used for cleaning, for example, hard surfaces or automobiles. The semi-rigid gel article provides a metered dose of active to be added to an amount of water before use.

### Treatment System (Kit)

The semi-rigid gel article of the present invention may be combined in the form of a treatment system (treatment kit or kit). The treatment system may further contain instructions for use of the semi-rigid gel article, including a list of suitable surfaces and substrates that may be treated and application techniques.

In one embodiment, the treatment system includes the inventive semi-rigid gel article packaged in a blister pack, optionally including instructions for proper application and use of the semi-rigid gel article to clean or sanitize hands with or without water. In one embodiment, instructions would include the number of dose aliquots to use, the desired method of applying the semi-rigid gel article to the hands, and contact time.

In another embodiment, instructions would be in the form of textual instructive steps, while in another embodiment, instructions would be in the form of visually recognizable pictographs representing the desired application steps in a non-verbal format. In yet another embodiment, instructions would be in the form of an audible transmitted message, such as in a digital recording, to provide auditory instructions as to the desired application steps. In one embodiment, the audible message would be a musical tone that persisted in time to a sufficient period to denote the desired contact time to prompt a user to continue rubbing their hands to effect complete cleaning or disinfection. In yet another embodiment, instructions would be in the form of a visual color change imparted to the semi-rigid gel article, such as for example employing a disappearing colored dye system known in the art that changes the semi-rigid gel article upon the user's hand from a first color to a second color, optionally a non-visible second color, after a particularly desirable time interval after contact with the user's hand.

### EXAMPLES

The compositions and data illustrated in the Examples illustrate specific embodiments of the compositions of the present invention, but are not intended to be limiting thereof. Other modifications can be undertaken by the skilled artisan without departing from the spirit and scope of this invention

All exemplified compositions can be prepared by conventional formulation and mixing techniques. Component amounts are listed as amounts listed in percentage (“%'s”) are in weight percent of the composition alone and exclude minor materials such as fillers, etc., typically used to modify the compositions characteristics.

The batch sizes of the Examples prepared herein ranged from 100 grams to 400 grams. However, the batch size could be scaled up or scaled down without undue experimentation.

### Example 1

### Preparation of a Semi-Rigid Gel Article

### Formulation 1

| Component | Mass (grams) |
|---|---|
| Corn starch | 6 |
| Glycerin | 3 |
| Water | 91 |

Corn starch from GPC of Iowa, glycerin from Uniqema of Illinois, and water was added to a beaker. Next, the beaker was placed on a hot plate and held in place with a clamp. Then the composition was mixed well with a series mixer from Yamato Labo-Stirrer, Model LR-41D, with a roto speed about 400-500 rpm. The hotplate was then turned to a medium-high temperature and the solution was mixed constantly. The composition was heated past its gelatinization temperature to about 90° C. to 95° C. The process took about 30-40 minutes. The temperature was held for about 5 minutes to allow the composition to gel. Next, the hotplate was turned off, the mixer still operating as before, and the gel was allowed to cool to about 80° C. to form a paste like consistency. The stirrer was turned off once the composition cooled.

Next, a bead like semi-rigid gel article was formed by dropping 1-3 ml aliquots of the paste via a pipette onto a Teflon® coated surface. The beads were allowed to cool to room temperature and set-up for about 1.5 hours or until they could be handled.

### Example 2

### Preparation of a Semi-Rigid Gel Article

### Formulation 2

| Component | Mass (grams) |
|---|---|
| Corn starch | 12 |
| Water | 188 |

Corn starch from GPC of Iowa, and water was added to a beaker. Next, the beaker was placed on a hot plate and held in place with a clamp. Then the composition was mixed well with a series mixer from Yamato Labo-Stirrer, Model LR-41D, with a roto speed about 400-500 rpm. The hotplate was then turned to a medium-high temperature and the solution was mixed constantly. The composition was heated past its gelatinization temperature to about 90° C. to 95° C. The temperature was held for about 5 to 10 minutes to allow the composition to gel. Next, the hotplate was turned off, the mixer still operating as before, and the gel was allowed to cool to about 80° C. to form a paste like consistency. The stirrer was turned off once the composition cooled.

Next, a bead like semi-rigid gel article was formed by dropping 1-3 ml aliquots of the paste via a pipette onto a Teflon® coated surface. The beads were allowed to cool to room temperature and set-up for about 1.5 hours or until they could be handled.

### Example 3

### Preparation of Semi-Rigid Gel Article with Silver Dihydrogen Citrate

### Formulation 3

| Component | Mass (grams) |
|---|---|
| Corn starch | 6 |
| Glycerin | 3 |
| Water | 90 |
| Silver Dihydrogen Citrate (0.003% active) | 1 |

A starch based semi-rigid gel article according to Example 1 was prepared. Silver dihydrogen citrate (TINOSAN®) from Ciba was added to the starch, water, plasticizer composition before any processing was started. The beads of this experiment could be handled gently.

### Example 4

### Preparation of a Semi-Rigid Gel Article with Actives Encapsulated in Beadlets

### Formulation 4

| Component | Mass (grams) |
|---|---|
| Corn starch | 12 |
| Glycerin | 6 |
| Water | 182 |
| Active Beadlets² | 2-3 of each type |

²Beadlets from Induchem of Switzerland each separately filled with Glycolic Acid, Lactic Acid, Silver dihydrogen Citrate, and Color. Beadlet size range from 500 μm to 1500 μm.

² Beadlets from Induchem of Switzerland each separately filled with Glycolic Acid, Lactic Acid, Silver dihydrogen Citrate, and Color. Beadlet size range from 500 μm to 1500 μm.

First, active beadlets from Induchem were rehydrated in water before they could be added to the starch composition. The beadlets contained the following actives: 1) glycolic acid; 2) lactic acid; 3) silver dihydrogen citrate; and 4) color. Accordingly, about 2-3 grams of each type of beadlet was added to about 20 ml of water and soaked for about 2 hours. The water was drained before addition to the starch composition.

A starch paste according to Example 1 was prepared. Once the composition cooled, the stirrer was turned off and the paste like composition was split into 4 even beakers. The four different hydrated active beadlets were gently hand mixed into one of the four beakers. A semi-rigid gel article according to Example 1 was then formed. All the beads of this experiment set up solidly and could be handled regularly.

### Example 5

### Preparation of a Semi-Rigid Gel Article with Surfactants

### Formulation 5

| | Component | Mass (grams) |
|---|---|---|
| Beaker A | Corn starch | 12 |
| | Glycerin | 6 |
| | Water | 180 |
| | Beadlets with Shea butter³ | 3 |
| | Walnut shells (60/100) | 2 |
| | APG (50% active) | 2-3 |
| | Lemon Oil | 2 ml |
| Beaker B | Corn starch | 12 |
| | Glycerin | 6 |
| | Water | 180 |
| | Beadlets with Orange Oil³ | 3 |
| | Walnut shells (35/60) | 1.5 |
| | APG (50% active) | 2-3 |
| Beaker C | Corn starch | 12 |
| | Glycerin | 6 |
| | Water | 182 |
| | Beadlets with Orange Oil³ | 3 |
| | Walnut shells (35/60) | 1.5 |
| | APG (50% active) | 10 |
| Beaker D | Corn starch | 12 |
| | Glycerin | 6 |
| | Water | 182 |
| | Beadlets with Shea butter³ | 3 |
| | Walnut shells (60/100) | 2 |
| | APG (50% active) | 10 |
| Beaker E | Corn starch | 12 |
| | Glycerin | 6 |
| | Water | 173 |
| | Beadlets with Orange Oil³ | 7 |
| | Walnut shells | 4 |
| | Sodium lauryl sulphate (30% active) | 9 |

³Beadlets from International Specialty Products (ISP) of New Jersey. Beadlet size ranges from 25 μm to 1350 μm.

A starch paste according to Example 1 was prepared. Once the composition cooled, the stirrer was turned off and the paste like composition was split evenly into four beakers: Beaker A, Beaker B, Beaker C and Beaker D.

To beaker A, blue beadlets filled with shea butter were added and mixed in by hand. (The ISP beadlets do not need to be rehydrated before addition to the composition.) Then fine walnut shell (60/100) and lemon oil were mixed in by hand. Then, APG (50% active) was added to the beaker and mixed and blended well.

To beaker B, coarse walnut shells (35/60) were mixed in with the mixer. Then, ISP beadlets filled with orange oil were added and mixed in by hand. Then, APG (50% active) was added to the beaker and mixed until blended well.

To beaker C, beadlets filled with orange oil were added and mixed in by hand. Then, APG (50% active) was added to the beaker and mixed until blended well.

To beaker D, blue beadlets filled with shea butter were added and mixed in by hand. Then, APG (50% active) was added to the beaker and mixed until blended well.

A bead like semi-rigid gel article according to Example 1 was then formed. The articles of beakers A, B, C and D set up solidly and could be handled regularly.

To test the effect of the surfactant, a users hands were wetted and the semi-rigid gel article was rubbed vigorously between the hands. The bead matrices of Beakers A and B experienced a small amount of foaming. The bead matrices of Beakers C and D foamed well. The samples were wrapped tightly in cellophane and allowed to sit overnight. The samples were then retested the next morning and the foam capabilities re-evaluated. The matrices from Beakers A and B did not foam as well. The matrices from Beakers C and D foamed the same.

In another Example, Beaker E, a starch based paste according to Example 1 was prepared. Then beadlets filled with orange oil were added and mixed in by hand. Then, sodium lauryl sulphate (SLS) (30% active) WA-Extra from Stepan of Illinois and walnut shells were added to the beaker and mixed until blended well.

A bead like semi-rigid gel article according to Example 1 was then formed. The bead semi-rigid gel article of Beaker E set up solidly and could be handled regularly. To test the effect of the surfactant, a users hands were wetted and the semi-rigid gel article was rubbed vigorously between the hands. The semi-rigid gel article of Beaker E foamed well. The sample was wrapped tightly in cellophane and allowed to sit over night. The sample was retested in the morning and the foam capabilities were the same.

### Example 6

### Method to Evaluate Sanitizing Effect on a Surface

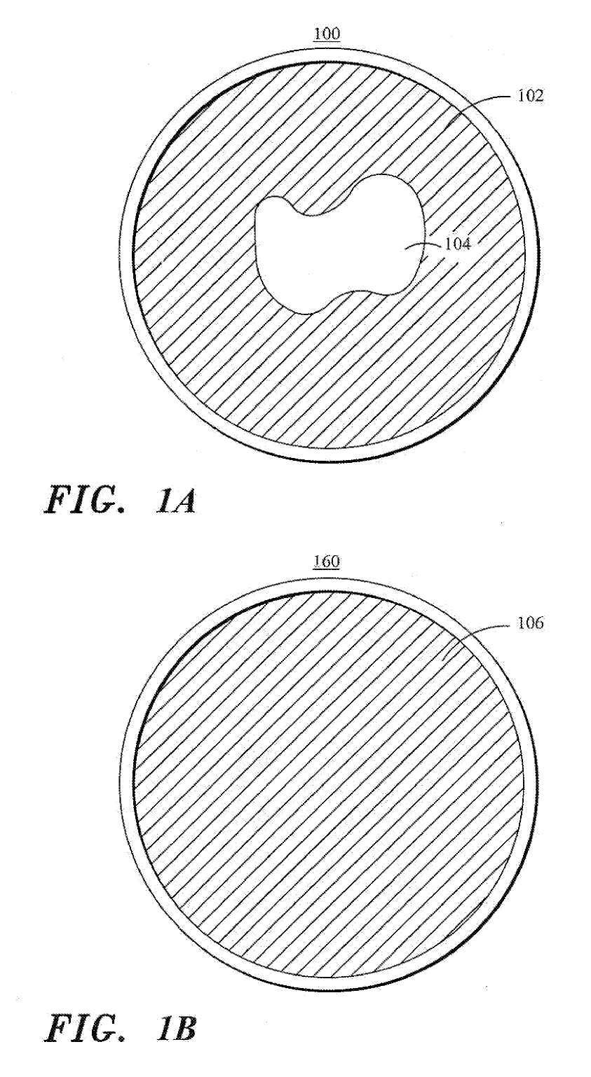

The ability of a semi-rigid gel article incorporated with an antimicrobial agent to disinfect a surface contaminated with a microorganism, Salmonella choleraesuis, was tested. The effectiveness of the semi-rigid gel article was determined by measuring its zone of inhibition. The results are depicted in FIGS. 1a and 1b. This method can also be applied to test the ability of other antimicrobial agents to inhibit the growth of other microorganisms.

The method includes testing the semi-rigid gel article of Example 3, Formulation 3, which includes the antimicrobial active silver dihydrogen citrate (TINOSAN®), and Example 4, Formulation 4, which includes one semi-rigid gel article incorporated with beadlets from Induchem and filled with lactic acid; one semi-rigid gel article incorporated with beadlets from Induchem and filled with glycolic acid and one semi-rigid gel article incorporated with beadlets from Induchem and filled with TINOSAN®. Next, an overnight culture of S. cholerasuis was diluted 1:1000 with Butterfield's buffer. Then 1.0 ml of the diluted culture was delivered onto the surface of a TSA plate (100) and (160) to cover the entire agar surface (102) and (106). Next, the excess liquid was decanted and the plate (100) and (160) was placed in a 35° C. incubator and allowed to absorb the inoculum for 15-30 minutes.

Next, the articles containing beadlets of active ingredient were crushed to “release” the active ingredient. Accordingly, these samples were placed between 2 microscope cover slips and compressed to 1) crush the beads and release the active and 2) provide a flat uniform area for contact with the contaminated agar surface. Excess product was squeezed out of the two slides and discarded. The top cover slip was removed and the flattened, “activated” sample was placed flat on the inoculated plate (100) and (160), compressed to allow complete contact with the surface and allowed to rest for 1 min. After 1 min, the product slide was aseptically removed and discarded and the plate was incubated overnight at 35° C., and examined for inhibition of growth of microorganisms.

FIG. 1a shows a depiction of the results obtained from the plates (100) in contact with the starch semi-rigid gel article incorporated with TINOSAN® or lactic acid beadlets. Accordingly, FIG. 1a shows a zone of inhibition (104), which indicates that after 1 min. of contact, the TINOSAN® and lactic acid beadlets were able to prevent the growth of S. cholerasuis on the contaminated surface (102). FIG. 1b shows a depiction of the results obtained from the plates (160) in contact with the semi-rigid gel article incorporated with glycolic acid beadlets and TINOSAN® beadlets, which shows no inhibition occurred on the contaminated surface (106). This may be because the active was not completely released from the beadlets or active leached out of the beadlets during rehydration.

### Example 7

### Method to Evaluate Water Content of Semi-Rigid Gel Article Made of Starch

Starch based bead like articles according to Example 1 were prepared. Several different samples were prepared and the ratio of starch to glycerin was varied from 1:1, 2:1 (Formulation 1) and 6:1. The water content of the articles was determined by first weighing the semi-rigid gel article at room temperature (i.e., initial bead weight). Then weighing the semi-rigid gel article after resting at room temperature for 24 hours. Finally, weighing the semi-rigid gel article after baking in an oven at 50° C. overnight (i.e., final semi-rigid gel article weight). The following formula was used to calculate the water weight percent:

$$\frac{( initial bead weight - final bead weight )}{( initial bead weight )}$$

The results are shown below in Table 1.

TABLE 1
Water Content of Semi-Rigid Gel Article

| | | | Semi-rigid | | |
|---|---|---|---|---|---|
| | | | gel article | Semi-rigid gel | |
| | | Semi-rigid | weight at | article weight | |
| | | gel article | t = 24 hrs. | after baking | |
| | Starch:Glycerin | weight at | (room | overnight at | Wt % |
| No. | Ratio | t = 0 | temp) | 50° C. | Water |
| 1 | 1:1 | 1.3043 | 0.7535 | 0.2326 | 82.2 |
| 2 | 1:1 | 1.2576 | 0.7256 | 0.2268 | 82.0 |
| 3 | 2:1 | 1.2932 | 0.7087 | 0.1491 | 88.5 |
| 4 | 2:1 | 1.3266 | 0.7857 | 0.1509 | 88.6 |
| 5 | 6:1 | 1.2220 | 0.6693 | 0.1501 | 87.7 |
| 6 | 6:1 | 1.0419 | 0.4197 | 0.1094 | 89.5 |

t = time

### Example 8

### Method to Evaluate Water Content of Semi-Rigid Gel Article Made of Agar

A mixture containing 2% (w/w) agar (Bacto-Agar, Difco Laboratories, Detroit, Mich.) in water was mixed at 330 rpm and heated in a pressure reactor at a rate of 2° C./min. until the temperature reached 100° C. The solution was then cooled to 60° C. using an internal cooling coil. The solution was injected under pressure (0.069-0.14 MPa) through supply lines and through four disposable needles (23G1) into rotating (15 rpm) container of chilled (10° C.) vegetable cooking oil. The injection stream formed small (1-3 mm) spherical semi-rigid gels that settled at the bottom of the container. The agar gels were recovered by filtration, washed three times in hexane to remove the oil residue, and stored in chilled (5° C.) water until needed. The final moisture content of the gels was determined by oven drying at 60° C. until no further reduction in weight could be detected. The final moisture content was 98%.

### Example 9

### Method to Evaluate Water Content of Semi-Rigid Gel Article Made of Algin

A mixture containing 1% (w/w) alginic acid (Sigma, St. Louis, Mo.) in water was mixed and heated in a pressure reactor at a rate of 2° C./min. until the temperature reached 100° C. The molten solution was injected into a 1% CaCl₂ (w/w) solution in which it formed spherical semi-rigid gel articles. The final moisture content of the gels was determined by oven drying at 60° C. until no further reduction in weight could be detected. The final moisture content was 98% and were stored in chilled 1% CaCl₂ (w/w) solution until needed.

### Example 10

### Method to Evaluate Gel Strength and Viscosity of Semi-Rigid Gel Article

Dynamic Mechanical Analyzer (DMA) analysis was used to measure the storage modulus (i.e., elastic modulus), loss modulus (i.e., viscous modulus), and the complex viscosity (i.e., the frequency-dependent viscosity function determined during forced harmonic oscillation of shear stress; contains both real and imaginary parts) of the inventive articles.

### Formulation 7

| | Starch:Glycerin | | |
|---|---|---|---|
| | Ratio | Component | Mass (grams) |
| A | 12:2 | Cornstarch | 12 |
| | | Glycerin | 2 |
| | | Water | 89 |
| B | 12:6 | Cornstarch | 12 |
| | | Glycerin | 6 |
| | | Water | 88 |
| C | 12:12 | Cornstarch | 12 |
| | | Glycerin | 12 |
| | | Water | 77 |
| D | 6:1 | Cornstarch | 6 |
| | | Glycerin | 1 |
| | | Water | 101 |
| E | 6:3 | Cornstarch | 6 |
| | | Glycerin | 3 |
| | | Water | 92 |
| F | 6:6 | Cornstarch | 6 |
| | | Glycerin | 6 |
| | | Water | 90 |

Samples A-F of Formulation 7 were formed into a paste according to Example 1. Each paste was then spread in a petri dish about 5 mm thick. The samples were allowed to set up overnight. The samples were then cut into a cylindrical shape with a 12 mm diameter, 4 mm thick, for analysis in a DMA 2980 in the temperature range of about −25° C. to about 45° C. A 15 mm compression clamp attachment was used in the single frequency mode with a temperature sweep from −25° C. to about 45° C. The amplitude of oscillation was set to 25.0 μm, the pre-load force was set to 0.010N, the force track was set to 125% and the frequency was set to 1 Hz. Set-up for the DMA is as follows:
Program: Universal V4.1D
TA Instruments Thermal Analysis—DMA Multi Frequency-Compression Method Log:
1: Data storage: Off
2: Equilibrate at 45.00° C.
3: Isotherm for 2.00 min.
4: Data storage: on
5: Ramp 2.00° C./min. to 25.00° C.
6: Isothermal for 2.00 min.
7: Ramp 2.00° C./min. to 5.00° C.
8: Isothermal for 2.00 min.
9: Ramp 2.00° C./min. to −10.00° C.
10: Isothermal for 2.00 min.
11: Ramp 2.00° C./min. to −25.00° C.
12: End of method.

Two of each sample were analyzed, except for three of Sample E was analyzed. The average value of the runs is shown in FIG. 2, FIG. 3, and FIG. 4. Differences in observed behaviors are likely due to defects (e.g., air bubbles or lumps) between samples.

Accordingly, at about 15° C.-25° C. the semi-rigid gel article of the present invention has a storage modulus of about 2 kPa to about 22 kPa (FIG. 2). In another embodiment, the storage modulus is about 2 kPa to about 6 kPa. In another embodiment, the semi-rigid gel article has a loss modulus of about 0.3 kPa to about 5 kPa (FIG. 3). In another embodiment, the loss modulus is about 0.4 kPa to about 1 kPa. In yet another embodiment, the semi-rigid gel article has a complex viscosity about 13 cP to about 120 cP (FIG. 4). In another embodiment, the complex viscosity is about 10 cP to about 30 cP. In another embodiment, the semi-rigid gel article has a dynamic viscosity of about 1.5 cP to about 23 cP at 15° C.-25° C. In yet another embodiment, the dynamic viscosity is about 1.5 cP to about 3.5 cP.

We claim:

1. A semi-rigid gel article for disinfecting a surface comprising:
a) about 4% by weight to about 30% starch;
b) about 60% to about 90% water;
c) about 0.001% by weight to about 10% by weight antimicrobial agent; and
wherein the semi-rigid article has a storage modulus of at least 2 kPA and a loss modulus of at least 0.3 kPa at about 15° C.-25°; and
wherein the semi-rigid article is capable of disinfecting a surface by contacting the surface with the article, rupturing the article by application of pressure and spreading the article on the surface to deliver the antimicrobial agent.

2. The semi-rigid gel article of claim 1 wherein, the semi-rigid gel article comprises a porous matrix having a solid phase and wherein the pores are at least partially filled with the water.

3. A semi-rigid gel article for disinfecting a surface comprising:
a) a gelling agent;
b) water;
c) an antimicrobial agent; and
wherein the semi-rigid gel article is capable of disinfecting a surface by contacting the surface with the article, rupturing the article by application of pressure and spreading the article on the surface to deliver the antimicrobial agent.

4. The semi-rigid gel article of claim 3 wherein, the semi-rigid gel article comprises a porous matrix having a solid phase and wherein the pores are at least partially filled with the water.

5. The semi-rigid gel article of claim 3 wherein, the water content is about 60% by weight to about 90% by weight of the article.

6. The semi-rigid gel article of claim 3 wherein, the semi-rigid gel article has a storage modulus of at least 2 kPA and a loss modulus of at least 0.3 kPa at about 15° C.-25°.

7. The semi-rigid gel article of claim 3, wherein the gelling agent is selected from the group consisting of starch, agar, alginate, cellulose, cellophane, collodion, protein, gelatin, silica, and alumina or a combination thereof.

8. The semi-rigid gel article of claim 7, wherein the gelling agent is starch.

9. The semi-rigid gel article of claim 8 wherein, the starch content is about 4% by weight to about 30% by weight.

10. The semi-rigid gel article of claim 8 wherein, the starch has an amylose content of about 10% by weight to about 40% by weight.

11. The semi-rigid gel article of claim 8 wherein, the starch is unmodified

12. The semi-rigid gel article of claim 3 further comprising a plasticizer.

13. The semi-rigid gel article of claim 12 wherein, the plasticizer is selected from the group consisting of polyhydric alcohol, amino alcohols, hydroxyalky amides, and mixtures thereof.

14. The semi-rigid gel article of claim 12 wherein, the plasticizer content is about 1% by weight to about 10% by weight.

15. The semi-rigid gel article of claim 3 wherein, the antimicrobial agent is about 0.001% by weight to about 10% by weight of the article.

16. The semi-rigid gel article of claim 3 wherein, the antimicrobial agent is selected from the group consisting of a biguanide, natural, acid, chitosan, quats, phenols and metal.

17. The semi-rigid gel article of claim 3, wherein the antimicrobial agent provides a zone of inhibition of growth of microorganisms.

18. The semi-rigid gel article of claim 3 wherein, the semi-rigid gel article has a diameter of about 6 mm to about 50 mm.

19. The semi-rigid gel article of claim 3 wherein, the semi-rigid gel article is incorporated with a beadlet ranging in size from about 25 μm to about 2000 μm.

20. The semi-rigid gel article of claim 3 wherein, the surface is an animate surface.

21. The semi-rigid gel article of claim 20 wherein, the animate surface is human skin.

22. A semi-rigid gel article comprising:
a) a gelling agent;
b) water;
c) an antimicrobial agent; and
wherein the semi-rigid gel article is of a sufficient mechanical strength to allow the entire gel to be picked up without breaking, and
wherein the gelling agent forms a solid matrix that is able to hold solids, liquids or solutions.

23. The semi-rigid gel article according to claim 22, wherein the semi-rigid gel article is capable of disinfecting a surface by contacting the article with the surface, rupturing the article by application of pressure and spreading the article on the surface to deliver the antimicrobial agent.

24. A method for disinfecting a surface with a semi-rigid gel article comprising,
a) providing a semi-rigid gel article comprising water, a gelling agent and an antimicrobial agent;
b) contacting the semi-rigid gel article with the surface;
c) rupturing the semi-rigid gel article by applying pressure and spreading the article on the surface to deliver the antimicrobial agent.
d)
